(19) United States
(12) Patent Application Publication
(10) Pub. No.: US 2025/0287340 A1
(43) Pub. Date: Sep. 11, 2025

(54) Method and 5G Core Network Entity for Ranging/Sidelink Positioning Service Authorization to NG-RAN

(71) Applicant: BEIJING XIAOMI MOBILE SOFTWARE CO., LTD., Beijing (CN)

(72) Inventor: Yang SHEN, Beijing (CN)

(21) Appl. No.: 18/862,462

(22) PCT Filed: May 6, 2022
(86) PCT No.: PCT/CN2022/091326

§ 371 Date: Nov. 1, 2024

(51) Int. Cl. H04W 64/00; H04W 8/22; H04W 12/06; H04W 92/18

(52) U.S. Cl. CPC H04W 64/00; H04W 8/22; H04W 12/06; H04W 92/18

(57) ABSTRACT

The invention is related to a method and a 5G core network entity for Ranging/Sidelink positioning service authorization to next generation radio access network (NG-RAN). An access and mobility management function (AMF) of the core network receives information about PC5 capability of a user equipment (UE) for Ranging/Sidelink positioning of a user equipment, obtains information related to service authorization for Ranging/Sidelink positioning from a UDM, sends an indication information indicating that the UE is authorized to use Ranging/Sidelink positioning service to the NG-RAN.

### CROSS-REFERENCE TO RELATED APPLICATION

This application is the U.S. National Stage Application of International Application No. PCT/CN2022/091326, filed on May 6, 2022, the entire disclosure of which is incorporated herein by reference.

### TECHNICAL FIELD

The invention is related to wireless communication, in particular to solutions for service authorization to a next generation radio access network (NG-RAN) for Ranging/Sidelink Positioning in a fifth generation (5G) network system.

### BACKGROUND

Nowadays, while connecting to a cellular network, a user equipment (UE) or terminal node may communicate directly with other UEs or terminal nodes through PC5 interfaces. This communication without data going through the network may be referred as sidelink communication, and the UEs can be vehicles, Road Side Units (RSUs), mobile terminal and etc.

Via PC5 interface, it is possible to perform a number of sidelink services, for example, Vehicle-To-Everything (V2X) communication services, Proximity based Services (ProSe), Ranging and Sidelink positioning and so on.

Generally, Ranging refers to the determination of distance, direction, and/or relative position of one UE (i.e. Target UE) from another UE (i.e. Reference UE) via PC5 interface. Sidelink positioning means positioning of the UE using PC5. It may provide geographic position and/or velocity of a Target UE based on measuring via PC5 interface.

The term Reference UE refers to a UE which determines a reference plane and/or reference direction in Ranging/Sidelink positioning based services. The term Target UE refers to a UE whose positioning parameter is measured in the distance Ranging/Sidelink positioning based services. The positioning parameter may include at least one of the Target UE's distance, direction and/or position relative to the reference plane, the reference direction and/or the location of a Reference UE, as well as its geographic position and/or velocity. Further, in the task of Ranging/Sidelink positioning, a UE may also act as an Assistant UE which provides assistance for Ranging/Sidelink positioning when a direct Ranging/Sidelink positioning between a Reference UE and a Target UE is not possible.

It is noted that, while using services over PC5 interface, a UE can operate in either Scheduled resource allocation mode or UE autonomous resource allocation mode. When operating in the Scheduled resource allocation mode, a NG-RAN allocates and/or schedules transmission resources for the PC5 communication of the UE and it is necessary to provision service authorization information to the NG-RAN. This also applies to Ranging/Sidelink positioning services.

It is an object of the present invention to provide solutions for Ranging/Sidelink positioning service authorization to NG-RAN to fill the blank in this field.

### SUMMARY OF THE INVENTION

A first aspect of present invention provides a method for authorising to use Ranging/Sidelink position service to NG-RAN. In this method, an Access and Mobility Management Function (AMF) receives information about PC5 capability of the UE for Ranging/Sidelink positioning; obtains information related to service authorization for Ranging/sidelink positioning from a Unified Data Management (UDM); and then sends an indication information indicating that the UE is authorized to use Ranging/Sidelink positioning service to a NG-RAN.

As a second aspect of present invention, a 5G core network entity includes an AMF and a UDM, which is capable of controlling and operating the service authorization to NG-RAN for Ranging/Sidelink positioning. The AMF is configured to receive information about PC5 capability of a UE for Ranging/Sidelink positioning, obtain information related to service authorization for Ranging/sidelink positioning from the UDM, and send an indication information indicating that the UE is authorized to use Ranging/Sidelink positioning service to a NG-RAN.

As a third aspect of present invention, an electronic device, comprising a processor and a memory configured to store instructions executable by the processor is provided. The processor is configured to call the executable instructions in the memory to execute the service authorization method discussed above in the first aspect.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 shows a block diagram illustrating an example 5G network system

FIG. 2 shows a flow chart of a first embodiment of the present invention

FIG. 3 shows a flow chart of a second embodiment of the present invention

FIG. 4 shows a block diagram of a 5G network system

### DETAILED DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

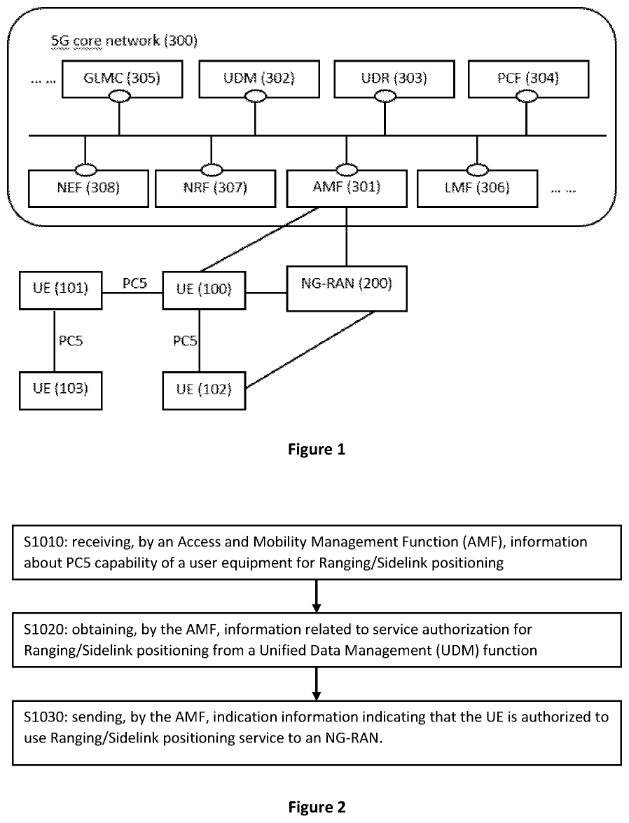

FIG. 1 shows a block diagram of a possible application scenario for 5G network system with sidelink communication. In FIG. 1, while connecting to a NR-RAN (200), a UE (100) may communicate with other UEs (101, 102) via PC5 interface. Simultaneously, both the NG-RAN (200) and the UE (100) may also be configured to communicate directly with a AMF (301) implemented in a 5G core network entity (300). Generally, the AMF (301) may support establishing encrypted signalling connection towards the UE, allowing it to register, to be authenticated and to move between different radio cells in the network. The AMF may also support paging the UE when it is in CM-IDLE state.

Further, the 5G core network entity (300) includes a UDM which serves as a front-end for the user subscription data stored in the User Data Repository (UDR) of the core network (300). It is also possible for the UDM to store the user subscription data locally. The 5G network system illustrated in FIG. 1 may include other essential or non-essential entities or functions not depicted.

The direct communication between UEs via PC5 interface may use Licensed, unlicensed and/or ITS spectrum (spectrum for intelligent transport systems). These spectrums may be different in different countries. As discussed in the background, while performing Ranging/Sidelink positioning tasks via PC5 interface, the UE (100) may operate in either Scheduled resource allocation mode or UE autonomous resource allocation mode. Particularly, for operating in the Scheduled resource allocation mode, it might be necessary to provide service authorization information for Ranging/Sidelink positioning of the UE (100) to the NG-RAN (200) so that it can be authorized to allocate and/or schedule PC5 transmission resources for the UE (100).

FIG. 2 depicts a flow chart of a method for Raging/Sidelink positioning service authorization to NG-RAN according to present invention.

In step S1010, a AMF receives information about PC5 capability of a UE for Ranging/Sidelink positioning. Specifically, the information about PC5 capability for Ranging/Sidelink positioning may be reported by the UE. The information may indicate whether the UE is capable to user Ranging/Sidelink positioning service over PC5 reference point (interface) and/or which specific PC5 Radio Access Technology (RAT) it supports, i.e. LTE PC5 only, NR PC5 only or both LTE and NR PC5.

In step S1020, the AMF obtains information related to service authorization for Ranging/Sidelink positioning from a UDM. The information related to service authorization may be obtained by the UDM from a UDR or stored locally in the UDM.

Optionally, the information may be included as part of subscription data of the UE and stored in the UDR or UDM. In this case, the AMF may acquire the subscription data from the UDM so as to obtain the information from the subscription data. It is noted that the AMF and the UDM should be implemented in one 5G core network.

In step S1030, the AMF sends indication information indicating that the UE is authorized to use Ranging/Sidelink positioning service to an NG-RAN, in response to determining that the UE is PC5 capable and is authorized to use Ranging/Sidelink positioning service. In this context, PC5 capable for Ranging/Sidelink positioning means that the UE has the ability to use Ranging/Sidelink positioning service. It may also indicate that ability of the UE to perform Ranging/Sidelink tasks via PC5 reference point as a Target UE, a Reference, an Assisted UE or any combination of these three roles.

By receiving the indication information, the NG-RAN knows that the UE is authorized to use Ranging/Sidelink positioning and it may allocate and/or schedule PC5 transmission resources for the UE to perform the Ranging/Sidelink positioning tasks. In other words, indication information is sent to the NG-RAN for the purpose of allowing the NG-RAN to allocate/schedule PC5 transmission resources for the UE to user Ranging/Sidelink positioning tasks. It may be noted that, when operating at the Scheduled resource allocation mode, the UE should be within the coverage of the NG-RAN. Specifically, the UE may be RRC_CONNECTED to the NG-RAN.

Optionally, as shown in FIG. 3, after obtaining (S1020) the information related to service authorization for Ranging/Sidelink information and before sending (1030) the indication information to the NG-RAN, the AMF may determine (S1021) whether the UE is authorized to use Ranging/Sidelink positioning service based on the information about PC5 capability of the UE for Ranging/Sidelink positioning and the information related to service authorization for Ranging/Sidelink positioning and send (S1030) indication information indicating that the UE is authorized to use Ranging/Sidelink positioning service to an NG-RAN, in response to determining that the UE is PC5 capable and is authorized to use Ranging/Sidelink positioning service.

In an embodiment of present invention, before sending the indication information, the AMF may store the PC5 capability for Ranging/Sidelink positioning locally, and store the obtained information related to Ranging/Sidelink positioning service authorization as part of the UE context locally. In particular, after receiving the PC5 capability (S1010), the AMF may store it directly as part of the UE context; and the information related to Ranging/Sidelink positioning may be stored after determination (S1021).

Optionally, instead of storing the obtained information, the AMF may store information about authorized PC5 capability of the UE for Ranging/Sidelink positioning. For example, when determining that the UE is only authorized to use LTE PC5 for Ranging/Sidelink positioning, the AMF stores only the information about LTE PC5 capability for Ranging/Sidelink positioning.

As discussed in the background, PC5 interfaces may also be employed for other services like V2X and/or 5G ProSe. It can be assumed that all UE capable of Ranging/Sidelink positioning are also capable for V2X/5G ProSe. Therefore, it is possible to consider the Ranging/Sidelink positioning as an extension to the V2X or 5G ProSe services. In this way, it is possible to incorporate the service authorization to NG-RAN for Ranging/Sidelink positioning as part of the V2X and/or 5G ProSe service authorization provision.

In an embodiment of the present invention, the service authorization to NG-RAN for Ranging/Sidelink positioning is included in the service authorization to NG-RAN for V2X. Therefore, in step S1010, the information about PC5 capability of the UE for Ranging/Sidelink positioning is included as part of the information about PC5 capability of the UE for V2X. In other words, when the AMF receives and stores the information about PC5 capability for V2X, it may receive and store the UE's PC5 capability for Ranging/Sidelink positioning simultaneously. Correspondingly, the information related to service authorization for Ranging/Sidelink positioning should be included in the V2X Subscription data of the UE. In a specific embodiment, it might be included in at least one of the NR V2X Services Authorization field and the LTE V2X Services Authorization field of the V2X Subscription date. The NR V2X and the LTE V2X refers to specific PC5 RATs the UE supports, i.e. NR PC5 and/or LTE PC5.

In addition, in this embodiment, the indication information indicating that the UE is authorized to use Ranging/Sidelink positioning service may also be included as part of the “V2X services authorized” indication. The AMF then sends the “V2X”. Thus, when receiving the “V2X services authorized” indication, the NG-RAN knows that the UE is authorized to use both V2X and Ranging/Sidelink positioning services and may allocate and/or schedule PC5 transmission resources for the UE to perform these services.

Optionally, before sending the indication information to NG-RAN, the AMF may include the “V2X authorized” indication in a NAGP message and then send it to the NG-RAN.

Moreover, in this embodiment, storing the information about PC5 capability for Ranging/Sidelink positioning refers to storing the information about PC5 capability of the UE for V2X which includes the information about PC5 capability for Ranging/Sidelink positioning. And the obtained information related to Ranging/Sidelink positioning service authorization is stored by the AMF as part of the V2X authorization information stored as part of the UE context.

Optionally, both the information about PC5 capability of the UE for Ranging/Sidelink positioning and the information related to Ranging/Sidelink positioning service authorization may be stored by the AMF as part of V2X Capability in the UE context. It is also alternative for the UE to store the information about PC5 capability of the UE for Ranging/Sidelink positioning and the information about authorized PC5 capability of the UE Ranging/Sidelink positioning as part of V2X Capability in the UE context.

In another embodiment of the present invention, the service authorization to NG-RAN for Ranging/Sidelink positioning is included in the service authorization to NG-RAN for 5G ProSe. Similarly to the V2X embodiment, in step S1010, the information about PC5 capability of the UE for Ranging/Sidelink positioning is included as part of the information about PC5 capability for 5G ProSe, which means when the AMF receives and stores the PC5 capability for 5G ProSe, it may acquire and stores the UE's PC5 capability for Ranging/Sidelink positioning simultaneously. In accordance, the information related to service authorization for Ranging/Sidelink positioning should be included in the 5G ProSe Subscription data of the UE.

Specifically, it might be included in the ProSe Services Authorization field of the ProSe Subscription date.

Moreover, in this embodiment, the indication information indicating that the UE is authorized to use Ranging/Sidelink positioning service may be included as part of the “5G ProSe authorized” indication. Thus, when receiving the “5G ProSe authorized” indication, the NG-RAN knows that the UE is authorized to use both 5G ProSe and Ranging/Sidelink positioning services and may allocate and/or schedule PC5 transmission resources for the UE to perform these services. As an option, before sending the indication information to NG-RAN, the AMF may include the “5G ProSe authorized” indication in a NAGP message and then send it to the NG-RAN.

In this embodiment, instead of storing the information about PC5 capability for Ranging/Sidelink positioning directly, the AMF stores the information about PC5 capability of the UE for 5G ProSe which includes the information about PC5 capability for Ranging/Sidelink positioning. And the obtained information related to Ranging/Sidelink positioning service authorization is stored by the AMF as part of the 5G ProSe authorization information which is stored as part of the UE context.

Alternatively, both the information about PC5 capability of the UE for Ranging/Sidelink positioning and the information related to Ranging/Sidelink positioning service authorization may be stored by the AMF as part of 5G ProSe Capability in the UE context. It is also alternative for the UE to store the information about PC5 capability of the UE for Ranging/Sidelink positioning and the information about authorized PC5 capability of the UE Ranging/Sidelink positioning as part of ProSe Capability in the UE context

Optionally, according another embodiment of present invention. The procedure of service authorization to NG-RAN for Ranging/Sidelink positioning may also be conducted independently. The UE may report the information about PC5 capability of the UE for

Ranging/Sidelink positioning to the AMF directly and the information related to service authorization for Ranging/Sidelink positioning is provided independently as Ranging/Sidelink positioning subscription data stored in the UDR or UDM. Accordingly, the indication information indicating that the UE is authorized to use Ranging/Sidelink positioning service may be provided as a “Ranging/Sidelink positioning services authorized” indication to the UE. Like the other two embodiments, before sending the indication information to NG-RAN, the AMF may include the “Ranging/Sidelink authorized” indication in a NAGP message and then send it to the NG-RAN.

Further, as mentioned in the background, when using Ranging/Sidelink positioning Services, a UE may act as a Target UE, a Reference UE, an Assisted UE or any combination of these three roles. It is possible for a UE to be capable and authorized to act solely as a Target UE, a

Reference UE or an Assisted UE. It is also possible for the UE to be capable and authorized to act as two roles among a Target UE, a Reference UE and a Assisted UE or even be capable and authorized to act as all these three roles. Hence, it might be necessary to distinguish which role a UE is capable of and authorized to act as.

Optionally, the information about PC5 capability for Ranging/Sidelink positioning received by the AMF should include respectively the UE's PC5 capability to act as at least one role among a Target UE, a Reference UE and an Assisted UE. For example, if the UE is act solely as an Assisted UE, the information about PC5 capability for Ranging/Sidelink positioning may indicate that the UE is capable to act as a Assisted UE and/or incapable of acting as a Target UE and a Reference UE. In another example, if the UE can act as all three roles, the PC5 capability for Ranging/Sidelink positioning should indicate that the UE is PC5 capable to act as a Target UE, the UE is PC5 capable to act as a Reference UE and the UE is PC5 capable to act as an Assisted UE. The examples given here are not exhaustive to include all scenarios.

Corresponding to this embodiment, the information related to service authorization for Ranging/Sidelink positioning should also indicate separately whether the UE is authorized to act as at least one role among a Target UE, a Reference UE and an Assisted UE. For example, if the UE is authorized to act as a Target UE and an Assisted UE, the service authorization information may indicate that the UE is authorized to act as a Target UE and an Assisted UE, and the UE is not authorized to act as a Reference UE.

Then, after obtaining the information related to service authorization for Ranging/Sidelink positioning, the AMF may determine respectively, whether the UE is authorized to act as at least one role among a Target UE, a Reference UE and an Assisted UE based on the information about PC5 capability for Ranging/Sidelink positioning and the information related to service authorization for Ranging/Sidelink positioning. In a specific example, if the information about PC5 capability of the UE indicates that the UE is PC5 capable to act as a Target UE and an Assisted UE and incapable of acting as a Reference UE while the information related to service authorization for Ranging/Sidelink positioning indicates that the UE is authorized to act as a Target UE and a Reference UE, the AMF will determine that the UE is only authorized to act as a Target UE and send the corresponding indication to the NG-RAN.

As an optional feature, after the determination, the AMF may store information about authorized PC5 capability of the UE for Ranging/Sidelink positioning as part of the UE context. For example, when determined that the UE is only authorized to act as a Target UE, the AMF stores only the UE's PC5 capability to act as an Target UE. More specifically, when determined that the UE is only authorized to act as a Target UE via NR PC5, the AMF stores only the UE's PC5 capability to act as an Target UE via NR PC5.

Optionally, the indication information may only be sent to a NG-RAN (S1030) during a Service Request Procedure, N2 Handover procedure of the UE. All the other method steps may be conducted in the Registration procedure of the UE. Specifically, when step S1030 is performed in Service Request Procedure, the NG-RAN is a NG-RAN to which the UE is connected to. When step S1030 is performed in N2 Handover Procedure, the NG-RAN is a target NG-RAN to which the UE switch to.

Further, it may happen that the UE is handed over to another target NG-RAN through Xn Handover Procedure. In this scenario, the source NG-RAN node which receives the indication information during Registration and/or Service Request Procedures may send the indication information to the target NG-RAN node. The source NG-RAN may include the indication information in a XnAP Hanover Request message or a Path Switch Request Acknowledge message and then send the message to the target NG-RAN. The target NG-RAN may then allocate and/or schedules PC5 transmission resources for the UE to user Ranging/Sidelink positioning service.

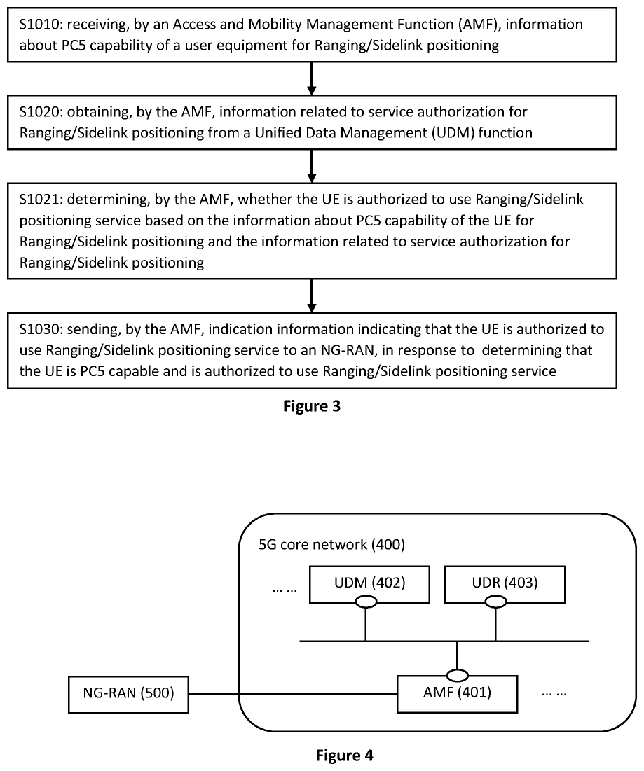

FIG. 4 shows an illustrative block diagram of a 5G network comprising a 5G core network entity (400) which is configured to control and perform the method steps for service authorization to NG-RAN for Ranging/Sidelink positioning as described above.

The 5G core network entity (400) comprising an AMF (401) and a UDM (402), where in the AMF is configured to receive information about PC5 capability of a user equipment (UE) for Ranging/Sidelink positioning, obtain information related to service authorization for Ranging/sidelink positioning from the UDM, determine whether the UE is authorized to use Ranging/Sidelink positioning service based on the information about PC5 capability of the UE for Ranging/Sidelink positioning and the information related to service authorization for Ranging/Sidelink positioning, and send an indication information indicating that the UE is authorized to use Ranging/Sidelink positioning service to a NG-RAN in response to determining that the UE is PC5 capable and is authorized to use Ranging/Sidelink positioning service.

With all these features, the 5G core network entity (400) informs the NG-RAN via AMF (401) that the UE is authorized to use Ranging/Sidelink positioning so as the NG-RAN can allocate and/or schedule PC5 transmission resources for the UE to perform the Ranging/Sidelink positioning tasks.

In another embodiment where the information related to service authorization for Ranging/sidelink positioning is included in subscription data of the UE, the AMF (401) is further configured to obtain subscription data from of the UE from the UDM. Optionally, the subscription data of the UE maybe stored in the UDR (403) or UDM (402).

Optionally, the AMF (401) may also be configured to store the information about PC5 capability of the UE for Ranging/Sidelink positioning, and the obtained information related to Ranging/Sidelink positioning service authorization as part of the UE context, before sending the indication information. Alternatively, instead of the obtained information, the AMF may be configured to store information about authorized PC5 capability of the UE for Ranging/Sidelink positioning as part of the UE context.

Further, when the service authorization to NG-RAN for Ranging/Sidelink positioning is included in the service authorization to NG-RAN for V2X/5G ProSe, the AMF may be configured to include the indication information as part of a “V2X services authorized” indication or a “5G ProSe authorized” indication of the UE. When the service authorization to NG-RAN for Ranging/Sidelink positioning is implemented independently, the AMF may be configured to include the indication information as a “Ranging/Sidelink positioning services authorized” indication of UE.

Further, the AMF may be optionally configured to store both the information about PC5 capability of the UE for Ranging/Sidelink positioning and the information about authorized PC5 capability of the UE for Ranging/Sidelink positioning as part of V2X capability or ProSe capability of the UE context.

Optionally, the AMF may be configured to include the indication in a NGAP message and send the message to the NG-RAN.

In another embodiment of present invention, the AMF may also be configured to send the indication information to a target NG-RAN in N2 Handover Procedure.

It is noted that the 5G core network system illustrated in FIG. 4 may include other essential and non-essential entities or functions not related to present invention, which are not shown in FIG. 4.

The 5G network system may further comprise at least one NG-RAN nodes, which is configured to receive the indication information and allocate and/or schedule the PC5 transmission resources for the UE to use Ranging/Sidelink positioning services.

In addition, the NG-RAN may act as an source NG-RAN node during a Xn Handover Procedure and sends the indication information to the target NG-RAN node. In particular, the source NG- RAN may include the indication information in a XnAP Hanover Request message or a Path Switch Request Acknowledge message and then send the message to the target NG-RAN.

Further, the Ranging/Sidelink positioning authorization method may be implemented by a electronic devices. The electronic device comprises a processor and a memory configured to store instructions executable by the processor; wherein the processor is configured to call the executable instructions in the memory to execute the service authorization method as discussed above.

It is appreciated by those skilled in the art that the described functions in the embodiments of the present disclosure may be implemented by hardware, software, firmware or any combination thereof in the above one or more examples. When implemented by using the software, these functions may be stored in a computer-readable medium or transmitted as one or more instructions or codes on the computer-readable medium. The computer-readable medium may include a computer storage medium and a communication medium. The communication medium includes any medium that facilitates the transmission of a computer program from one place to another place. The storage medium may be any available medium that can be accessed by a universal or dedicated computer.

An embodiment of the present disclosure further provides a non-temporary computer-readable storage medium, which stores a computer program; and the computer program is executed by a processor to implement the operations of the method for reporting the information.

In an embodiment, before sending the indication information to the NG-RAN, the AMF may determine whether the UE is authorized to use Ranging/Sidelink positioning service based on the information about PC5 capability of the UE for Ranging/Sidelink positioning and the information related to service authorization for Ranging/Sidelink positioning. And only in response to determining that the UE is PC5 capable and is authorized to use Ranging/Sidelink positioning service, the AMF sends the indication indicating that the UE is authorized to use Ranging/Sidelink positioning service to a NG-RAN.

In an embodiment, with the provisioning of the indication information, the NG-RAN knows that the UE is authorized to use Ranging/Sidelink positioning services. The NG-RAN may optionally allocate and/or schedule PC5 transmission resources for the UE to use Ranging/Sidelink positioning service.

Furthermore, it is optional for the AMF to store the PC5 capability of the UE for Ranging/Sidelink positioning before determining whether the UE is authorized to use Ranging/Sidelink positioning, and store information about authorized PC5 capability of the UE for Ranging/Sidelink positioning as part of the UE context after determining whether the UE is authorized to use Ranging/Sidelink positioning. Wherein the information about authorized PC5 capability of the UE indicates the PC capability that the UE is authorized.

In an embodiment, the information related to service authorization for Ranging/sidelink positioning may be included in subscription data of the UE, and the AMF acquires the subscription data of the UE from the UDM so as to obtain the information related to service authorization for Ranging/sidelink positioning.

In an embodiment, it is possible to incorporate the Ranging/Sidelink positioning service authorization procedure as an extension to service authorization to NG-RAN for V2X. The information about PC5 capability of the UE for Ranging/Sidelink positioning may be included as part of information about PC5 capability for V2X provided by the UE, and the information related to service authorization for Ranging/sidelink positioning is included in V2X Subscription data of the UE. In addition, the indication information sent to the NG-RAN may also be included as part of a “V2X services authorized” indication of the UE.

In an embodiment, the AMF may store the PC5 capability of the UE for Ranging/Sidelink positioning before and the information about authorized PC5 capability of the UE for Ranging/Sidelink positioning as part of V2X Capability the UE context.

It is also possible to incorporate the Ranging/Sidelink positioning service authorization procedure as an extension to service authorization to NG-RAN for 5G ProSe. If so, the information about the PC5 capability of the UE for Ranging/Sidelink positioning may be included as part of information about PC5 capability for 5G ProSe provided by the UE, and the information related to service authorization for Ranging/Sidelink positioning is included in 5G ProSe Subscription data of the UE. Additionally, the indication information sent to the NG-RAN may also be included as part of a “5G ProSe authorized” indication of the UE.

In an embodiment, the AMF may store the PC5 capability of the UE for Ranging/Sidelink positioning and the information about authorized PC5 capability of the UE for Ranging/Sidelink positioning as part of 5G ProSe Capability the UE context.

With these two embodiments, service authorization to NG-RAN for Ranging/Sidelink positioning is accomplished while authorizing V2X or 5G ProSe to the NG-RAN, whereby no additional procedures are added, and communication resources can be saved.

In an embodiment, the Ranging/Sidelink positioning service authorization to NG-RAN may be performed independently. In this case, the subscription data obtained may be the “Ranging/Sidelink positioning subscription data” of the UE.

In addition to other embodiments, the information about PC5 capability of the UE for Ranging/Sidelink positioning may include PC5 capability of the UE to act as at least one role among an Target UE, a Reference UE and an Assistant UE. Correspondingly, the information related to service authorization for Ranging/Sidelink positioning may indicate whether the UE is authorized to act as at least one role among a Target UE, a Reference UE and an Assisted UE, and the indication information sent to the NG-RAN may indicate respectively that the UE is authorized to act as at least one role among these three roles. In this case, after obtaining the information related to service authorization for Ranging/Sidelink positioning, the AMF determines respectively whether the UE is authorized to act as at least one role among these three roles.

In another embodiment, the NG-RAN might be a target NG-RAN in N2 based handover procedure to which the UE will be handed over. Then, after obtaining the information related to service authorization for Ranging/Sidelink positioning or determining whether the UE is authorized to use Ranging/Sidelink positioning service, the AMF may send the indication information indicating that the UE is authorized to use Ranging/Sidelink positioning services to the target NG-RAN.

In another embodiment, when the UE is handed over from one source NG-RAN to a target NG-RAN via Xn Handover Procedure, then, after the AMF sends the indication information indicating that the UE is authorized to use Ranging/Sidelink positioning services to the source NG-RAN, the source NG-RAN may send the same indication information to the target NG-RAN.

It is to be understood that the term “multiple” in the present disclosure refers to more or more than two. The “and/or” is an association relationship for describing associated objects and represents that three relationships may exist. For example, A and/or B may represent the following three cases: only A exists, both A and B exist, and only B exists. The character “/” generally indicates that the related objects are in an “or” relationship.

Other embodiments of the present disclosure will be apparent to those skilled in the art from consideration of the specification and practice of the present disclosure disclosed here. This present disclosure is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A method for Ranging/Sidelink positioning service authorization to next generation radio access network (NG-RAN), comprising:
receiving, by an Access and Mobility Management Function (AMF), information about PC5 capability of a user equipment (UE) for Ranging/Sidelink positioning,
obtaining, by the AMF, information related to service authorization for Ranging/Sidelink positioning from a Unified Data Management (UDM) function, and
sending, by the AMF, indication information indicating that the UE is authorized to use Ranging/Sidelink positioning service to an NG-RAN.

2. The method of claim 1 further comprising;
before sending the indication information indicating that the UE is authorized to use Ranging/Sidelink positioning service to the NG-RAN,
determining, by the AMF, whether the UE is authorized to use Ranging/Sidelink positioning service based on the information about PC5 capability of the UE for Ranging/Sidelink positioning and the information related to service authorization for Ranging/Sidelink positioning, and
sending the indication information to the NG-RAN in response to determining that the UE is PC5 capable and is authorized to use Ranging/Sidelink positioning service,

3. The method of claim 1,
wherein the information related to service authorization for Ranging/sidelink positioning is included in subscription data of the UE, and
obtaining, by the AMF, information related to service authorization for Ranging/sidelink positioning from the UDM comprises:
obtaining, by the AMF, the subscription data of the UE from the UDM.

4. The method of claim 2, further comprising:
before determining whether the UE is authorized to use Ranging/Sidelink positioning service,
storing, by the AMF, the information about PC5 capability of the UE for Ranging/Sidelink positioning, and
in response to determining that the UE is authorized to use Ranging/Sidelink positioning service,
storing, by the AMF, information about authorized PC5 capability of the UE for Ranging/Sidelink positioning as part of the UE context.

5. The method of claim 3,
wherein the information about PC5 capability of the UE for Ranging/Sidelink positioning is included as part of information about PC5 capability of the UE for V2X,
the subscription data is V2X subscription data of the UE, and
the indication information is included as part of a “V2X services authorized” indication of the UE; or
the information about PC5 capability of the UE for Ranging/Sidelink positioning is included as part of information about PC5 capability of the UE for 5G ProSe, the subscription data is 5G ProSe subscription data of the UE, and the indication is included as part of a “5G ProSe authorized” indication of the UE.

6. The method of 5,
wherein storing, by the AMF, the information about PC5 capability of the UE for Ranging/Sidelink positioning, and storing information about authorized PC5 capability of the UE for Ranging/Sidelink positioning as part of the UE context comprise one of:
storing, by the AMF, the information about PC5 capability of the UE for Ranging/Sidelink positioning and the information about authorized PC5 capability of the UE for Ranging/Sidelink positioning as a part of V2X Capability in the UE context; or
storing, by the AMF, the information about PC5 capability of the UE for Ranging/Sidelink positioning and the information about authorized PC5 capability of the UE for Ranging/Sidelink positioning as a part of 5G ProSe Capability in the UE context.

7-8. (canceled)

9. The method of claim 3,
wherein the subscription data is Ranging/Sidelink positioning subscription data of the UE

10. The method of claim 1,
wherein the information about PC5 capability for Ranging/Sidelink positioning includes PC5 capability of the UE to act as at least one role among a Target UE, a Reference UE and an Assistant UE,
the information related to service authorization for Ranging/Sidelink positioning indicates whether the UE is authorized to act as at least one role among a Target UE, a Reference UE and an Assistant UE,
the indication information indicates that the UE is authorized to act as at least one role among a Target UE, a Reference UE and an Assistant UE.

11. The method of claim 10, wherein,
determining, by the AMF, whether the UE is authorized to use Ranging/Sidelink positioning service comprises:
determining, by the AMF, whether the UE is authorized to act as at least one role among a Target UE, a Reference UE and an Assistant UE based on the information about PC5 capability of the UE for Ranging/Sidelink positioning and the information related to service authorization for Ranging/Sidelink positioning.

12. A 5G core network entity (400) comprising an AMF (401) and a UDM (402):
wherein the AMF is configured to receive information about PC5 capability of a user equipment (UE) for Ranging/Sidelink positioning,
obtain information related to service authorization for Ranging/sidelink positioning from the UDM, and
send an indication information indicating that the UE is authorized to use Ranging/Sidelink positioning service to a NG-RAN.

13. The 5G core network entity of claim 12,
wherein the AMF is configured to determine whether the UE is authorized to use Ranging/Sidelink positioning service based on the information about PC5 capability of the UE for Ranging/Sidelink positioning and the information related to service authorization for Ranging/Sidelink positioning before sending the indication information, and
send an indication information indicating that the UE is authorized to use Ranging/Sidelink positioning service to a NG-RAN in response to determining that the UE is PC5 capable and is authorized to use Ranging/Sidelink positioning service.

14. The 5G core network entity of claims 12,
wherein the information related to service authorization for Ranging/sidelink positioning is included in subscription data of the UE, and
the AMF is configured to obtain subscription data from of the UE from the UDM.

15. The 5G core network entity of claim 13, wherein the AMF is further configured to
store the information about PC5 capability of the UE for Ranging/Sidelink positioning before determining whether the UE is authorized to use Ranging/Sidelink positioning service, and
store information about authorized PC5 capability of the UE for Ranging/Sidelink positioning as part of the UE context in response to determining whether the UE is authorized to use Ranging/Sidelink positioning service.

16. The 5G core network entity of claim 14,
wherein the information about PC5 capability of the UE for Ranging/Sidelink positioning is included as part of information about PC5 capability of the UE for V2X,
the subscription data is “V2X subscription data” of the UE, and
the AMF is further configured to include the indication information as part of a “V2X services authorized” indication of the UE; or
the information about PC5 capability of the UE for Ranging/Sidelink positioning is included as part of information about PC5 capability of the UE for 5G ProSe, the subscription data is 5G ProSe subscription data of the UE, and the AMF is further configured to include the indication information as part of a “5G ProSe services authorized” indication of the UE.

17. The 5G core entity of claim 16,
wherein the AMF is further configured to store the information about PC5 capability of the UE for Ranging/Sidelink positioning and the information about authorized PC5 capability of the UE for Ranging/Sidelink positioning as part of V2X Capability in the UE context; or
wherein the AMF is further configured to store the information about PC5 capability of the UE for Ranging/Sidelink positioning and the information about authorized PC5capability of the UE for Ranging/Sidelink positioning as part of 5G ProSe Capability in the UE context.

18-19. (canceled)

20. The 5G core network entity of claim 14,
wherein the subscription data is “Ranging/Sidelink positioning subscription data” of the UE, and
the AMF is further configured to include the indication information as a “Ranging/Sidelink positioning services authorized” indication of UE.

21. The 5G core network entity of claim 12,
wherein the information about PC5 capability of the UE for Ranging/Sidelink positioning includes PC5 capability of the UE to act as at least one role among a Target UE, a Reference UE and an Assistant UE,
the information related to service authorization for Ranging/Sidelink positioning indicates whether the UE is authorized to act as at least one role among a Target UE, a Reference UE and an Assistant UE,
the indication information indicates that the UE is authorized to act as at least one role among a Target UE, a Reference UE and an Assistant UE

22. The 5G core network entity of claim 21,
wherein the AMF is configured to determine respectively whether the UE is authorized to act as least one role among a Target UE, a Reference UE and an Assistant UE based on the information about PC5 capability of the UE for Ranging/Sidelink positioning and the information related to service authorization for Ranging/Sidelink positioning.

23. (canceled)

24. An electronic device, comprising a processor and a memory configured to store instructions executable by the processor; wherein the processor is configured to:
receive information about PC5 capability of a user equipment (UE) for Ranging/Sidelink positioning,
obtain information related to service authorization for Ranging/Sidelink positioning from a Unified Data Management (UDM) function, and
send indication information indicating that the UE is authorized to use Ranging/Sidelink positioning service to an NG-RAN.

25. A non-transitory computer-readable storage medium, instructions in the storage medium being executed by a processor of an electronic device to cause the processor to execute the service authorization method of claim 1.
